(19) United States
(12) Patent Application Publication
(10) Pub. No.: US 2003/0105665 A1
(43) Pub. Date: Jun. 5, 2003

(54) Advertising article, system and method for cigarettes

(75) Inventor: Gregor Jankovic, Windsor (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Mind Box Creative Group Ltd., Windsor (CA)

(21) Appl. No.: 09/996,891

(22) Filed: Nov. 30, 2001

(51) Int. Cl. G06F 17/60

(52) U.S. Cl. 705/14

(57) ABSTRACT

An advertising article, an advertising method, and an advertising system relating to the provision of third party advertisements in association with conventional cigarette packaging The article can be in the form of an advertising sleeve which is adapted to fit over a conventional cigarette package or in the form of an advertising package which is adapted to hold a conventional number of conventional cigarettes. The advertising article includes a body portion having four display panels adapted for the display of advertising material, means for attaching a first one of said four display panels to a second one of said four display panels, where at least one of said display panels of the body portion is used to display advertising. The advertising method of providing an advertising article for cigarettes to an advertiser includes receiving instructions regarding advertising material from the advertiser over a communications network, printing said advertising copy material on the display panels of the advertising article, and delivering the advertising article to the advertiser.

### FIELD OF THE INVENTION

This invention relates to an advertising article, system and method for cigarettes and more particularly to the provision of third party advertisers with the ability to display their advertising in association with cigarette packaging.

### BACKGROUND OF THE INVENTION

Traditionally, various types of mobile or novelty-type advertising displays have proven to be an effective advertising medium. Businesses have used such advertising systems in various forms, from a person wearing a sandwich board to the visual depiction of certain goods or other indicia representing the source of goods on the side of a truck or other moving vehicle. More recently, public transportation buses entirely wrapped in electrostatic marking film bearing advertising graphics have been utilized within urban areas for their advertising impact on consumers.

Many kinds of containers, and particularly those associated with beverage, food or other personal consumption items, are typically placed in public view, and therefore are appropriate for use as display surfaces for various kinds of advertising and promotion. The concept of providing advertising to consumers in association with various consumer goods is disclosed in U.S. Pat. No. 6,299,918 to Morgese. This patent discloses a pizza server that allows the user to consume a slice of pizza with the added convenience of a peel-away pizza platform. Advertising and promotional material is provided directly on the pizza server by imprinting information on the server.

### SUMMARY OF THE INVENTION

The present invention provides an advertising article for cigarettes having display surfaces, said advertising article comprising:

(a) a body portion having four display panels, separated by folding creases running longitudinally from a top to a bottom of the body portion;

(b) means for attaching a first one of said four display panels to a second one of said four display panels, said means comprising a folding portion foldably connected to said first one of said four display panels and being attachable to the underside of said second one of said four display panels; and

(c) at least one of said display panels of said body portion being used to display advertising material.

The present invention also provides a method for providing an advertiser with an advertising article for a cigarette package, said advertising article having display panels that feature advertising material, said method comprising the steps of:

(a) receiving instructions regarding the advertising material from the advertiser over a communications network;

(b) printing said advertising material on the display panels of the advertising article to produce the advertising article; and

(c) delivering said advertising article to the advertiser.

The present invention also provides a system for providing an advertiser with an advertising article for cigarettes, said advertising article having display panels that feature advertising material, said system comprising:

(a) a communications network;

(b) an advertising center coupled to said communications network, said advertising center being adapted to receive instructions regarding the advertising material from the advertiser over the communications network;

(c) means for printing said advertising material on the display panels of the advertising article; and

(d) means for delivering said advertising article to the advertiser.

The present invention also provides a method for advertising comprising the steps of:

(a) manufacturing an advertising article having at least four display panels; and

(b) printing advertising material on at least one of the display panels of the advertising article.

The present invention also provides a method of using an advertising article having display surfaces, said method comprising the steps of:

(a) receiving an advertising article having front and back display panels said advertising article being adapted to display advertising material; and

(b) using said advertising article in association with cigarettes.

### BRIEF DESCRIPTION OF THE DRAWINGS

In the accompanying drawings:

FIG. 1 is a perspective view of an advertising sleeve according to one example of the present invention;

FIG. 2 is a front view of the advertising sleeve of FIG. 1 in an unassembled configuration when not in use;

FIG. 3 is a perspective view of the advertising sleeve of FIG. 1 where the advertising sleeve has been installed on a cigarette package with advertising featured on the front and back panels of the advertising sleeve;

FIG. 4 is a perspective view of an advertising package according to another example of the present invention.

FIG. 5 is a front view of the advertising package of FIG. 4 in an unassembled configuration when not in use;

FIG. 6 is a block diagram of the advertising system of the present invention;

FIG. 7 is a flowchart illustrating the steps taken by an advertiser when ordering advertising sleeves or advertising packages within the advertising system of FIG. 5 according to the present invention;

FIG. 8 is a flowchart illustrating the steps taken by an administrator of the advertising center of the advertising system of FIG. 5 to manage orders for advertising sleeves or advertising packages initiated by an advertiser according to the present invention; and

FIG. 9A, 9B, 9C and 9D are sample Web browser screens which are provided to the Web clients of advertisers A to N of FIG. 5 when the advertiser places an on-line order for the advertising sleeves or advertising packages of the present invention.

### DETAILED DESCRIPTION OF THE INVENTION

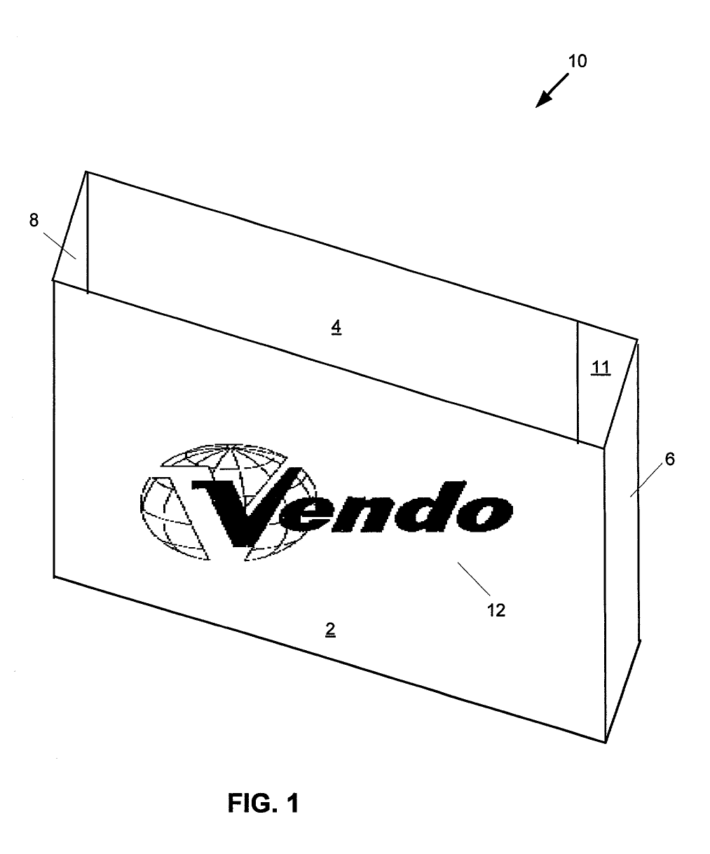

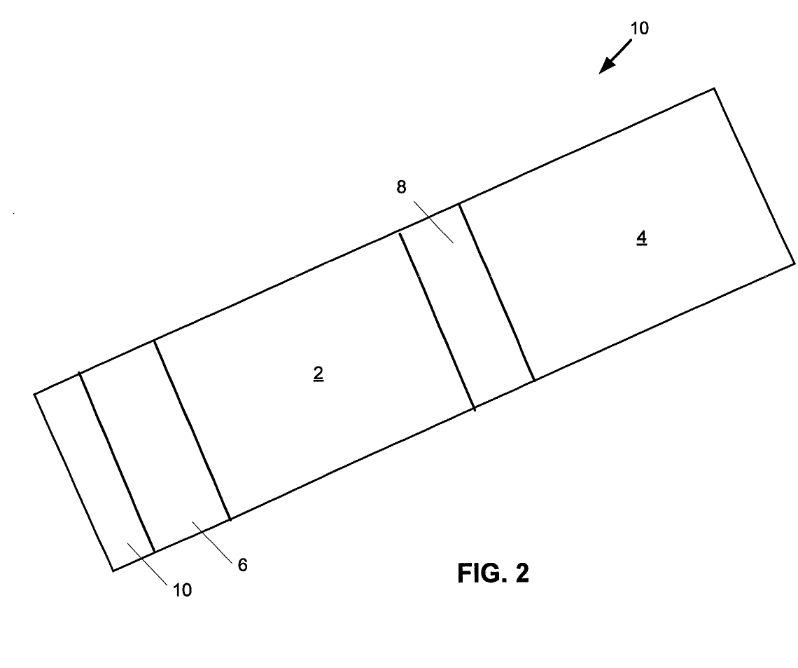

FIG. 1 is a front perspective view of an advertising sleeve 10, made in accordance with one example of the invention. In this example, advertising sleeve 10 is to be utilized in association with a conventional cigarette package 20 as a cover-up sleeve. It should be understood that advertising sleeve 10 could be any required size to fit over the various sizes of conventional cigarette packages 20, for example, regular or large cigarette packages.

Advertising sleeve 10 comprises a number of panels including a front panel 2, a back panel 4, side panels 6 and 8, and an attachment tab 11. Advertising material 12 is featured on the outer surface of front panel 2 and on the outer surface of back panel 4 (not shown). However, it should be understood that advertising can be provided on any and all panels 2, 4, 6, and/or 8, as desired. Each of the four panels, namely the front panel 2, back panel 4, side panels 6 and 8 are connected by folding creases as shown.

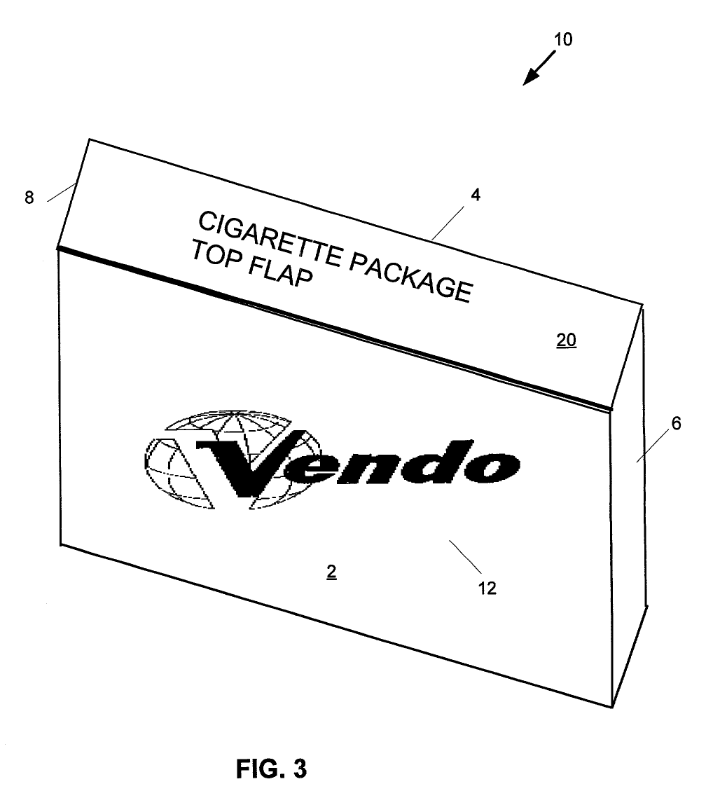

FIG. 2 shows advertising sleeve 10 in an unassembled state as it would be during shipping and handling. In this flat, unassembled configuration, printing of advertising material 12 on the panels 2, 4, 6, and/or 8 of advertising sleeve 10 can be accomplished. The attachment tab 11 is adapted to be attached to the inner surface of back panel 4 as shown in FIGS. 1 and 3 using adhesive placed on one or both of the outer edge of attachment tab 11 or the reciprocal portion of the inner edge of back panel 4. In this way, attachment tab 11 is used to provide support for advertising sleeve 10 when in the use configuration of FIGS. 1 and 3.

FIG. 3 is a perspective view of the advertising sleeve of FIG. 1 where advertising sleeve 10 has been installed on a cigarette package 20 with advertising 12 featured on the front and back panels (not shown) of the advertising sleeve 10. As noted, attachment tab 11 is used to provide more strength for supporting the cigarette package 20 to be contained within advertising sleeve 10.

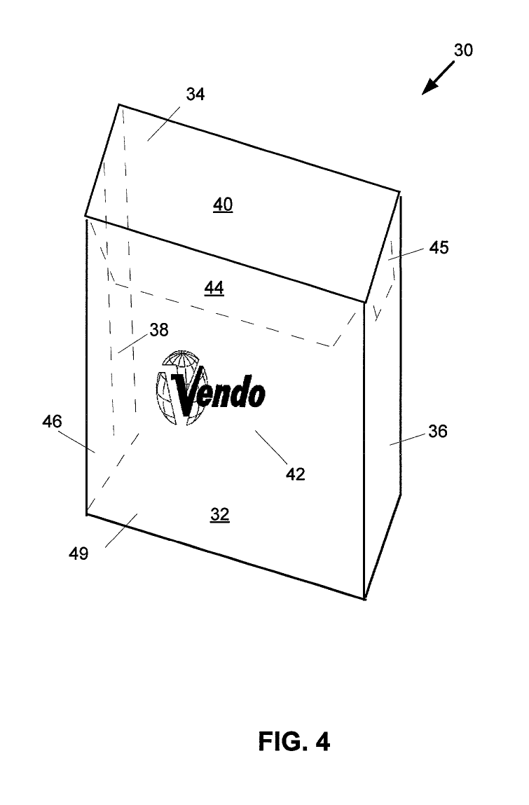

FIG. 4 is a front perspective view of the advertising package 30, made in accordance with another example of the invention. In this example, advertising package 30 is to be manufactured and sold as a separate container for cigarettes (not shown). It should be understood that advertising package 30 could be adapted to hold any size (regular or king-size) cigarettes or other smoking products (e.g. cigars or cigarette rolling papers).

Advertising package 30 comprises a number of panels including a front panel 32, a back panel 34, side panels 36 and 38, a top panel 40, top panel tabs 44, 45, and 47, an attachment tab 46 and a bottom panel 49. Advertising material 12 is featured on the outer surface of front panel 2 and on the outer surface of back panel 4 (not shown). However, it should be understood that advertising can be provided on any and all panels 32, 34, 36, 38, 40, and/or 49, as desired. Each of the four panels, front panel 32, back panel 34, side panels 36 and 38 are connected by folding creases as shown.

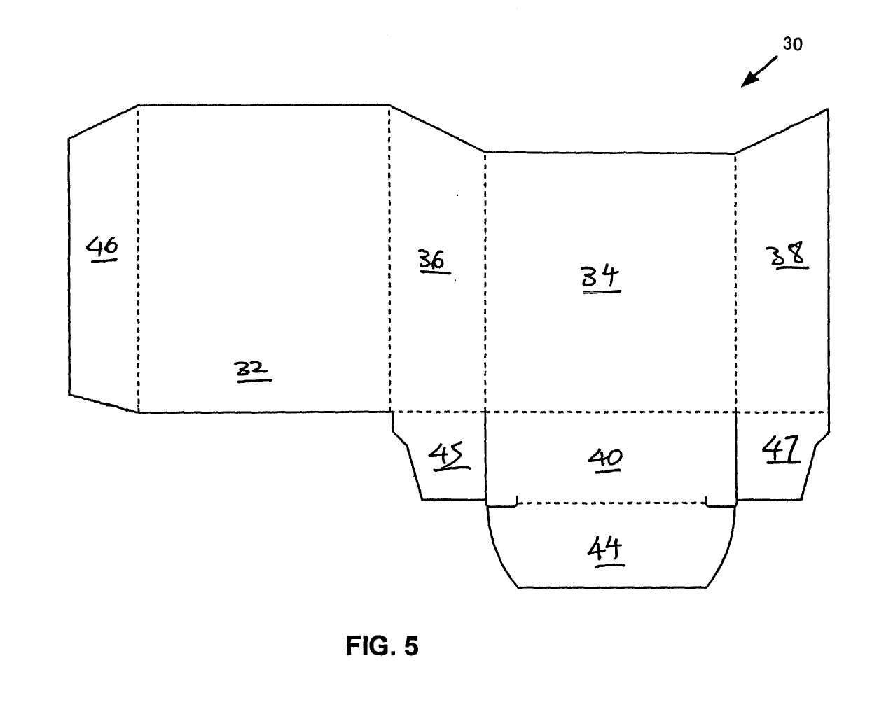

FIG. 5 shows advertising package 30 in an unassembled state as it would be during shipping and handling. In this flat, unassembled configuration, printing of advertising material 42 on the panels 32, 34, 36, 38, 40, and/or 49 of advertising package 30 can be accomplished. The attachment tab 46 is adapted to be attached to the inner surface of side panel 38 as shown in FIG. 4 using adhesive placed on one or both of the outer edge of attachment tab 46 or the reciprocal portion of the inner edge of side panel 38. In this way, attachment tab 46 is used to provide support for advertising package 30 when in the use configuration of FIG. 4.

It should be understood that while an advertising sleeve 10 and an advertising package 30 have been illustrated and discussed, they are simply examples of the present invention and there are many other different types of containers on which could be imprinted advertising copy and which could be used in association with cigarette package 20 or cigarettes themselves. are contemplated by the present invention.

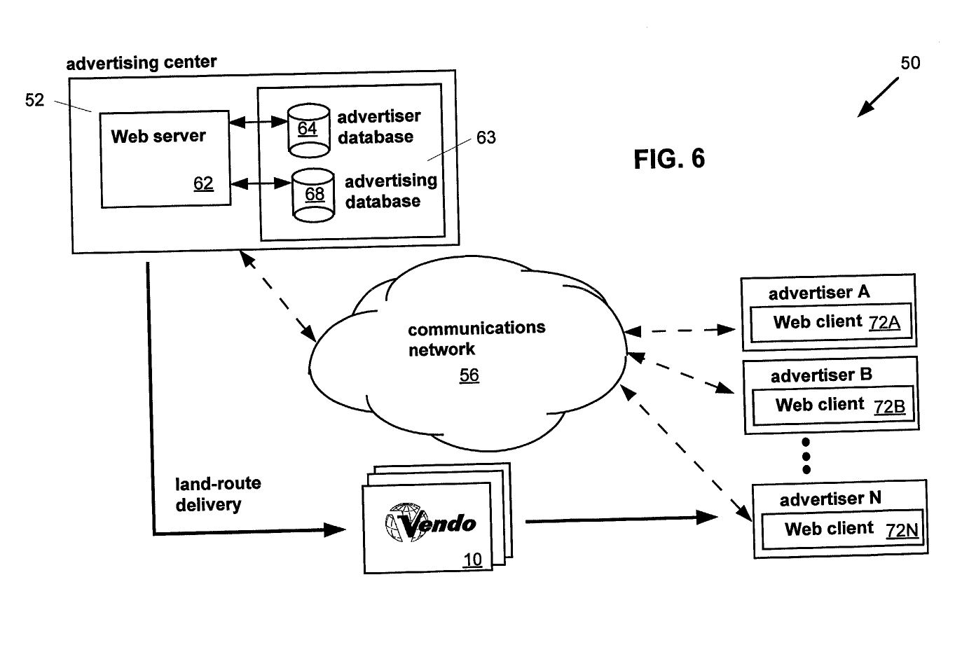

FIG. 6 is a block diagram of a preferred embodiment of a advertising system 50 in accordance with the present invention. System 50 comprises an advertising center 52 which provides a plurality of advertisers A to N with the ability to order customized advertising sleeves 10 or advertising packages 30 over a communications network 56 for land-route delivery as shown.

Communication network 56 is preferably the well known Internet computer network, based on a client server model which provides multimedia connection between advertisers A to N and advertising center 52. However, it should be understood that communication network 17 could be any other type of communication network, for example, such as a telephone network.

Advertising center 52 comprises a Web server 62 and a database server 63. Both Web server 62 and database server 63 are run using a conventional operating system such as Windows NT. Web server 62 utilizes Internet Information Server and database server 63 is implemented in Microsoft SQL 7.0 running on a Pentium III machine. Web server 62 hosts a multimedia Web site allowing advertisers A to N to view advertising material, to upload and download advertising material, to enter orders for advertising sleeves, and to provide on-line payment for purchase orders.

Database server 63 includes an advertiser database 64 and an advertising database 68. Advertiser database 64 contains information relating to the various subscribed advertisers A to N (e.g. name, mailing address for sleeve delivery, credit card and other billing information, etc.) Advertising database 68 contains image files for various types of advertising material (e.g. graphic elements that can be provided on-line to advertisers A to N for selection and historical advertising material for subscribing advertisers A to N). Since the hardware components of Web server 62 are conventionally known, they are not shown in detail. It should be understood that since advertising center 52 is implemented using Web server 62, advertising center 52 can be located anywhere that provides appropriate Internet access. It should be understood that while only one advertising center 52 has been discussed, a plurality (i.e. network) of advertising centers 52 could be provided within advertising system 50.

Advertisers A to N comprise a Web client 72A to 72N configured to access the Web site of the advertising center 52 in order to obtain information about advertising sleeves 10 or advertising package 30. Specifically, advertisers A to N will connect through Web client 72A to 72N to Web server 62. Web client 72A to 72N can be implemented on any type of computing platform such as personal computer (not shown) having installed Internet browsing software (e.g. Microsoft Explorer™ or Netscape™). Alternatively, any other kind of personal computing device that includes some form of interactive user interface (e.g. display and keyboard interface, verbal command driven interface, or combinations thereof etc.) such as personal digital assistants (PDA's) (e.g. Palm™, manufactured by Palm Inc. of California), Internet smart phones, personal laptop computers, and the like could be utilized as long as they contain software programs which provide the necessary communication functionality.

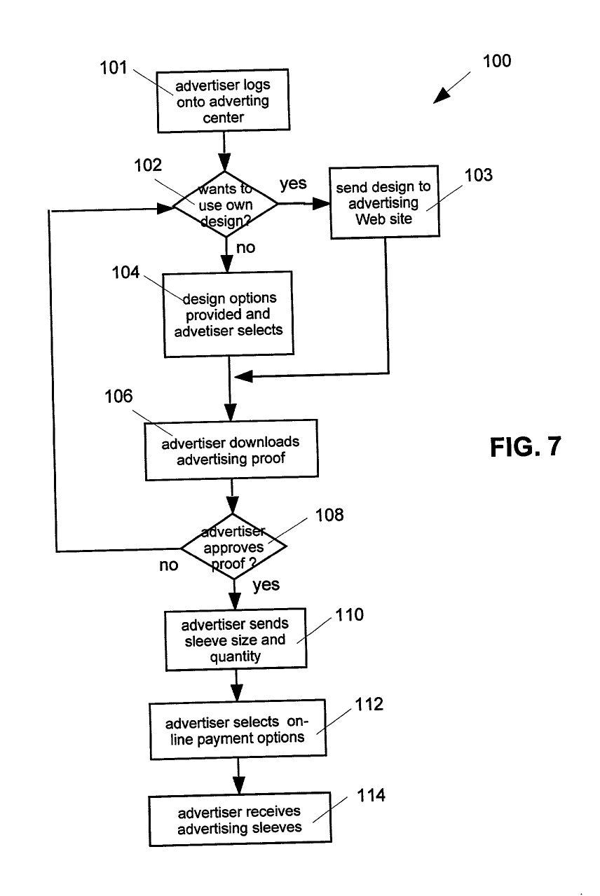

Referring now to FIGS. 6 and 7, a flowchart illustrating the steps 100 executed by the Web client 72A of advertiser A (for example) to obtain a customized order of advertising sleeves 10 or advertising packages 30 within the advertising method of the present invention is specifically shown in FIG. 7. While the following describes the interaction of one advertiser A with advertising center 52, it should be understood that simultaneous and concurrent utilization of advertising center 52 can occur by a number of advertisers A to N is contemplated.

At step (101), advertiser A uses Web client 72A to log onto advertising center 52. At step (102), advertiser A is asked and determines whether it will use it's own advertising material or select from the advertising material (e.g. suggested graphic elements, messages, fonts, etc.) provided by advertising center 52. If advertiser A is going to use it's own prepared advertising material (e.g. company logo or graphic art) then at step (103), advertiser A uses Web client 72A to upload the advertising material to the advertising center's 52 Web server 62. This advertising material (once again approved by advertiser A) will be stored in advertising database 68 as will be discussed in respect of the steps utilized by advertising center 52 (FIG. 6). If advertiser A does not provide it's own advertising material then at step (104), the advertiser is provided with various design options from which a selection is made.

At step (106), advertiser A utilizes Web client 72A to download the advertising proof from Web server 62 over communication network 56. At step (108), advertiser A either decides to accept the proof or not. If advertiser A does not accept the proof then returning to step (102) advertiser A must determine if they wish to use their own design material or make another selection from various design options. If advertiser A accepts the proof then advertiser A is prompted and enters the desired sleeve or package size (i.e. regular or large) and quantity of advertising sleeves 10 or advertising packages 30 desired at step (110). At step (112), advertiser A selects an appropriate on-line payment option (preferences and credit card numbers etc. may be stored for each advertiser A to N within advertiser database 64). Finally, advertiser A receives advertising sleeves 10 or advertising packages 30 by land-route delivery.

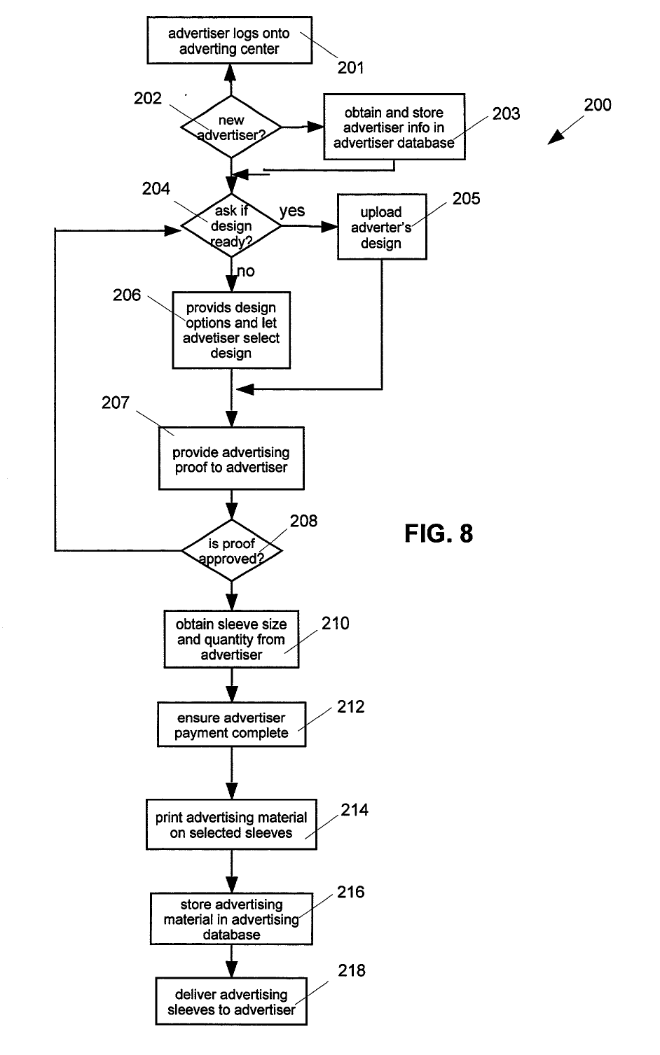

Referring now to FIGS. 6 and 8, a flowchart illustrating the steps executed 200 by the Web server 52 of advertising center 52 to provide each advertisers A to N with an order of customized advertising sleeves 10 or advertising packages 30 within the advertising method of the present invention is specifically shown in FIG. 8. While the following describes the activity of one advertiser A, it should be understood that simultaneous and concurrent utilization of advertising center 52 by a number of advertisers A to N is contemplated.

At step (201) advertiser A uses Web client 72A to log onto advertising center 52 (i.e. the Web server 62). Advertising center 52 then checks at step (202) whether advertiser A is a new advertiser. If so, then advertising center 52 queries advertiser A to obtain specific information about advertiser A (e.g. contact information, mailing address, credit card and billing information, etc.) and stores the information in advertiser database 64 at step (203). At step (204), advertising center 52 queries advertiser A whether advertiser has a design ready for submission or whether advertiser A would like to select and customize their advertising material from the advertising center's array of advertising material. If advertiser A has their own advertising material then at step (205), the advertising material is uploaded by advertiser to Web server 52 using Web client 72A over communication network 56. If advertiser A does not want to submit prepared advertising material, then at step (206), advertising center 52 provides advertiser A with design options and allows advertiser A to select and customize advertising material.

At step (207), advertising center 52 provides an advertising proof to advertiser A. If advertiser A does not approve the proof at step (208), then advertising center 52 again executes step (204) to determine whether advertiser A wishes to use their own advertising material or else to have advertiser re-select design elements to customize advertising material. At step (210), advertising center 52 queries and obtains the desired sleeve or package size (i.e. regular or large) and quantities. At step (212), on-line payment for the order is processed and advertising center 52 ensures that the advertiser payment is complete. At step (214), advertising center 52 prints, or directs a third party to print, advertising material on the selected sized sleeves 10 or advertising packages 30. At step (216), Web server 62 of advertising center 52 ensures that the selected advertising material for advertiser A is stored within advertising database 68 (i.e. to create a historical list of advertising material for advertiser A, should a repeat order be made). Finally, at step (218), advertising sleeves 10 or advertising packages 30 are delivered to advertiser A using land-route delivery, as shown in FIG. 4.

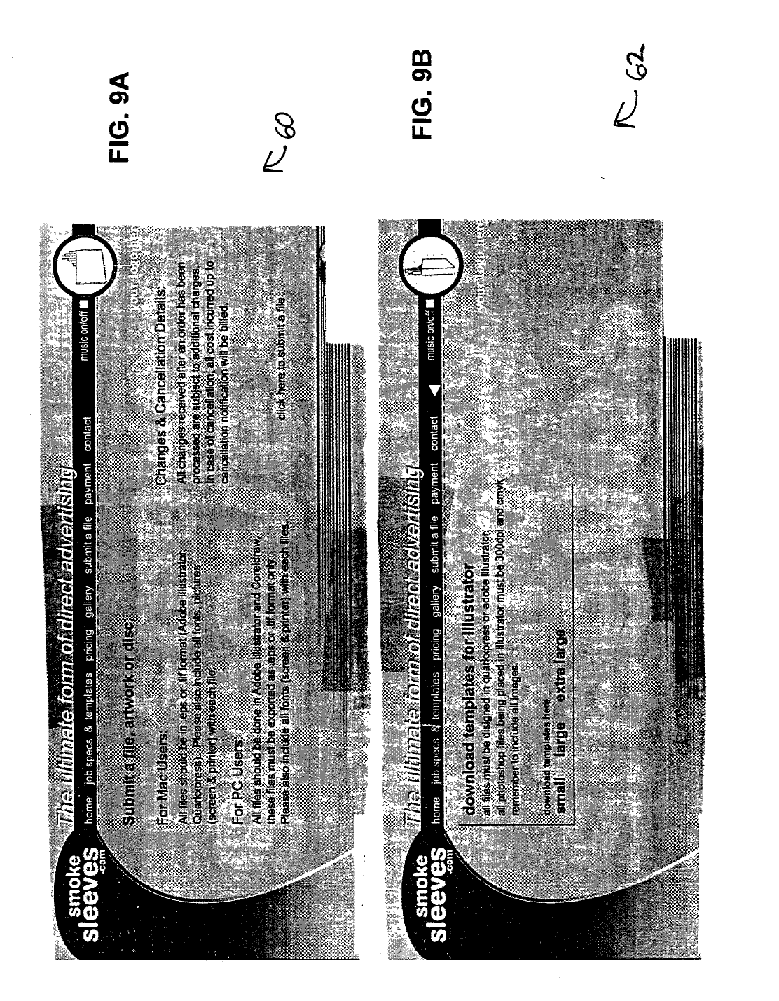

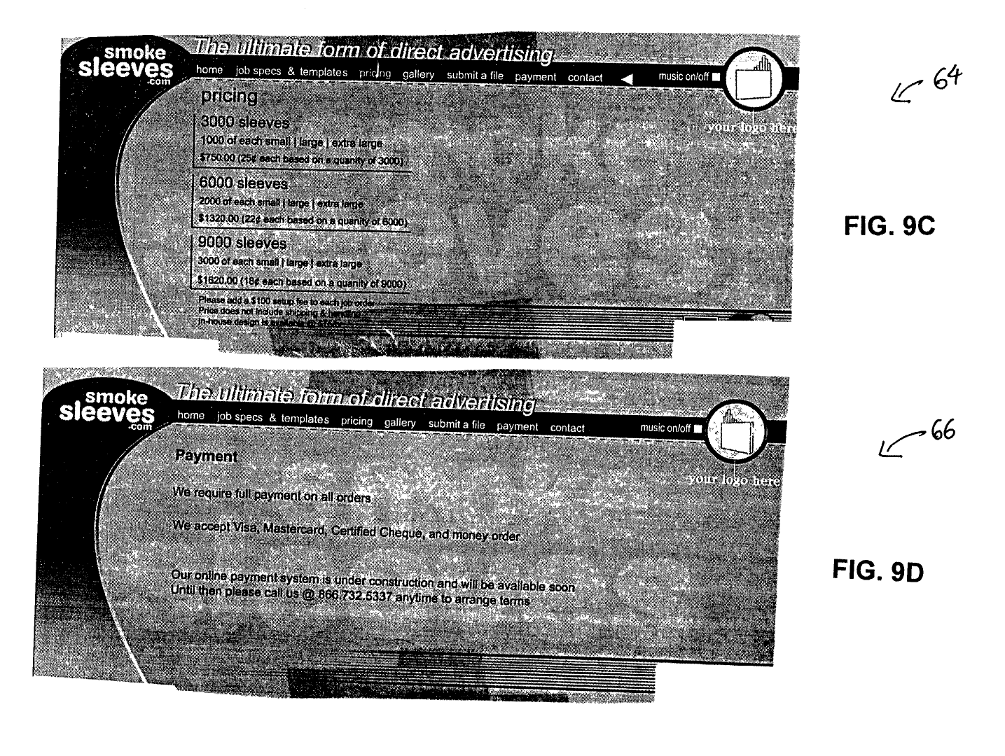

FIGS. 9A, 9B, 9C, and 9D are sample screen captures of the user interface provided by advertising system 50 as it is displayed within the Web browser of Web client 72A, shown generally as 60, 62, 64, and 66, respectively.

Specifically, FIG. 9A illustrates the user interface 60 which is provided to advertiser A to N when they are submitting advertising material (i.e. uploading) to Web server 52 of advertising center 52. As indicated, Web server 52 is adapted to receive .eps or .tif format documents (i.e. Abobe illustrator or Quarkxpress). Advertiser A is instructed by user interface 60 to provide all fonts, pictures (screen & printer) with each file.

FIG. 9B illustrates the user interface 62 which is provided to advertiser A to N when they are customizing existing templates stored in advertising database 68 and provided by Web server 62 to Web client 72A of advertiser A. As indicated, Web server 52 is adapted to provide downloads of Quarkxpress or Adobe illustrator.

FIG. 9C illustrates the user interface 62 which is provided to advertiser A to N when they are checking pricing of order (i.e. before selecting on-line payment options). As indicated, bulk discounts are available for larger orders.

FIG. 9D illustrates the user interface 64 which is provided to advertiser A to N when they are conducting on-line payment for the order of advertising sleeves 10 or advertising packages 30. As is conventionally, known, secure methods of funds transfer using encoded credit card information can be utilized for additional transactional security.

As will be apparent to those skilled in the art, various modifications and adaptations of the structure described above are possible without departing from the present invention, the scope of which is defined in the appended claims.

1. An advertising article for cigarettes having display surfaces, said advertising article comprising:
(a) a body portion having four display panels, separated by folding creases running longitudinally from a top to a bottom of the body portion;
(b) means for attaching a first one of said four display panels to a second one of said four display panels, said means comprising a folding portion foldably connected to said first one of said four display panels and being attachable to the underside of said second one of said four display panels; and
(a) at least one of said display panels of said body portion being used to display advertising material.

2. The advertising article of claim 1, wherein said folding portion is adhesively attached to the underside of said second one of said four display panels.

3. The advertising article of claim 1, wherein said body portion is formed of lightweight cardboard paper.

4. The advertising article of claim 1, wherein said body portion is a sleeve adapted to slide over the walls of a cigarette package.

5. The advertising article of claim 4, wherein said body portion covers the entirety of the display surfaces of the cigarette package.

6. The advertising article of claim 4, wherein advertising material is provided on all four display panels of said body portion.

7. The advertising article of claim 1, wherein said body portion including a bottom display portion and a top display portion, said top portion and bottom portion each being attached to one of said four display panels such that said article is a package adapted to hold cigarettes.

8. The advertising article of claim 7, wherein said advertising material is provided on all six display surfaces of said body portion.

9. A method for providing an advertiser with an advertising article for a cigarette package, said advertising article having display panels that feature advertising material, said method comprising the steps of:
(a) receiving instructions regarding the advertising material from the advertiser over a communications network;
(b) printing said advertising material on the display panels of the advertising article to produce the advertising article; and
(c) delivering said advertising article to the advertiser.

10. The method of claim 9, wherein said advertising material is provided by said advertiser over the communications network.

11. The method of claim 9, wherein said advertising material is selected by said advertiser over the communications network.

12. The method of claim 9, wherein said advertising article is an advertising sleeve adapted to slide over the walls of a cigarette package.

13. The method of claim 9, wherein said advertising article is an advertising package adapted to hold cigarettes.

14. A system for providing an advertiser with an advertising article for cigarettes, said advertising article having display panels that feature advertising material, said system comprising:
(a) a communications network;
(b) an advertising center coupled to said communications network, said advertising center being adapted to receive instructions regarding the advertising material from the advertiser over the communications network;
(c) means for printing said advertising material on the display panels of the advertising article; and
(d) means for delivering said advertising article to the advertiser.

15. The system of claim 14, further comprising a graphics center coupled to said communications network for preparing the advertising material according to the instructions received from the advertiser.

16. The method of claim 14, wherein said advertising article is an advertising sleeve adapted to slide over the walls of a cigarette package.

17. The method of claim 14, wherein said advertising article is an advertising package adapted to hold cigarettes.

18. A method for advertising comprising the steps of:
(a) manufacturing an advertising article having at least four display panels; and
(b) printing advertising material on at least one of the display panels of the advertising article.

19. The method of claim 18, wherein said advertising material is provided on all four display panels of said body portion.

20. The method of claim 18, wherein said advertising article is an advertising sleeve adapted to slide over the walls of a cigarette package.

21. The method of claim 18, wherein said advertising article is an advertising package adapted to hold cigarettes.

22. A method of using an advertising article having display surfaces, said method comprising the steps of:
(a) receiving an advertising article having front and back display panels said advertising article being adapted to display advertising material; and
(b) using said advertising article in association with cigarettes.

23. The method of claim 22, wherein said advertising article is an advertising sleeve and is adapted to have substantially the same dimensions as the dimensions of a cigarette package and wherein step (b) comprises sliding said advertising sleeve over the cigarette package.

24. The method of claim 22, wherein said advertising article is an advertising package and is adapted to hold cigarettes.
